(19) United States
(12) Patent Application Publication
(10) Pub. No.: US 2014/0100853 A1
(43) Pub. Date: Apr. 10, 2014

(54) Interactive Voice Response System

(71) Applicant: TOUCH NETWORKS PTY LTD, Melbourne (AU)

(72) Inventor: Jason Andrew Van, East Killara (AU)

(73) Assignee: TOUCH NETWORKS PTY LTD, Melbourne (AU)

(21) Appl. No.: 13/645,663

(22) Filed: Oct. 5, 2012

(51) Int. Cl. G10L 21/00

(52) U.S. Cl. 704/270.1; 704/E21.001

(57) ABSTRACT

An interactive voice response system, comprising: a processor configured to control the output of voice prompts for transmission to a user; an alphanumeric string generator controllable by the processor to generate a random or pseudo-random alphanumeric string for outputting by the processor to a user in natural language form; an input module for receiving a user response and configured to recognize alphanumeric characters in the user response and to output a recognized string of one or more alphanumeric characters recognized in the user response; and a validation module. The validation module is configured to receive the generated alphanumeric string from the alphanumeric string generator and the recognized string corresponding to the generated alphanumeric string from the input module, to compare the generated alphanumeric string with the recognized string, to determine whether the recognized string matches the generated alphanumeric string, and to output validation data in response to determining that the recognized string matches the generated alphanumeric string.

### FIELD OF THE INVENTION

The invention relates to an interactive voice response system, of particular by no means exclusive use in the provision of online retailing services.

### BACKGROUND OF THE INVENTION

An existing Interactive Voice Response (IVR) systems provide a user interface that allows users to interact with a computing system, such as over a telephone connection, whereby the computing system communicates with the user by voice recording or simulation and the user responds either by voice or dual tone multiple frequency (DTMF) tones using the keypad of the telephone. Certain existing IVR systems are employed in applications where user identification is required, such as to authorise a payment to the retailer providing the IVR system; DTMF keypad input provide in such implementation a mechanism for the secure input by the user of a password to the like.

### SUMMARY OF THE INVENTION

According to a first broad aspect, the present invention provides an interactive voice response system, comprising:
a processor configured to control the output of voice prompts (such as comprising a phrase or question) for transmission to a user;
an alphanumeric string generator controllable by the processor to generate a random or pseudo-random alphanumeric string for outputting by the processor to a user in natural language form;
an input module for receiving a user response and configured to recognize alphanumeric characters in said user response and to output a recognized string of one or more alphanumeric characters recognized in the user response; and
a validation module configured to receive the generated alphanumeric string from the alphanumeric string generator and the recognized string corresponding to the generated alphanumeric string from the input module, to compare the generated alphanumeric string with the recognized string, to determine whether the recognized string matches the generated alphanumeric string, and to output validation data in response to determining that the recognized string matches the generated alphanumeric string.

The voice prompts may be stored in audio form in a memory of the system, either as complete phrases or questions or as phrase or question components for assembly into complete phrases or questions. Alternatively, the voice prompts may be generated using a voice synthesis system of the system.

In one embodiment, the alphanumeric string generator is configured to output the generated alphanumeric string with each alphanumeric character rendered in a different voice.

In this embodiment, the system may include a voice selection module, configured to select respective voices randomly or pseudo-randomly from a set of available voices, or of recordings of characters, phrases or questions stored in a memory of the system, and to output said respective voices to said processor, wherein said processor is further configured to control the output of voice prompts according to said respective voices.

The input module, in one embodiment, recognises keypad inputs. In another embodiment the input module comprises a voice recognition system and can recognise voice inputs.

The generated alphanumeric string may comprise only one or more numerals (such as four digits), though in certain embodiments it comprises only one or more letters and in other embodiments a combination of one or more numerals and one or more letters.

In certain embodiments, the alphanumeric string generator is configured to change or select the length of the generated alphanumeric string periodically or randomly, or according to a predefined rule (such as each time a particular user interacts with the system).

In an embodiment, the system is configured to output the generated alphanumeric string in natural language form either with distortion or noise at a level that still allows identification of the generated alphanumeric string by the user. This makes it more difficult for the user to understand the alphanumeric string but makes it more difficult for the system to be abused by third parties with ‘robots’ equipped with voice recognition systems. The distortion or noise may, for example, be added to the generated alphanumeric string once converted into natural language form by the system, or the system may be provided with audio files corresponding to each alphanumeric character in distorted or noisy form, or the system may be provided a voice synthesis system configured to synthesize distorted or noisy voice output.

In a particular embodiment, the system includes a language controller, configured to control the processor to output a menu of language options, to receive user input indicative of a selected language from said menu of language options, and to control said processor to control the output of voice prompts in said selected language.

According to a second broad aspect, the present invention provides an interactive voice response method, comprising:
generating a random or pseudo-random alphanumeric string;
outputting the generated alphanumeric string to a user in natural language form;
receiving a user response from the user;
electronically recognizing alphanumeric characters in said user response;
outputting a recognized string of one or more alphanumeric characters recognized in the user response; and
electronically comparing the generated alphanumeric string with the recognized string;
determining whether the recognized string matches the generated alphanumeric string; and
outputting validation data in response to determining that the recognized string matches the generated alphanumeric string.

According to a third broad aspect, the present invention provides a payment system, comprising an interactive voice response system as described above.

According to a fourth broad aspect, the present invention provides computer software executable on a computing system for implementing the interactive voice response method as described above.

It should be noted that any of the various individual features of each of the above aspects of the invention, and any of the various individual features of the embodiments described therein including in the claims, can be combined as suitable desired.

### BRIEF DESCRIPTION OF THE DRAWING

In order that the invention may be more clearly ascertained, embodiments will now be described, by way of example, with reference to the accompanying drawing, in which:

FIG. 1 is a schematic view of a payment system according to an embodiment of the present invention;

FIG. 2 is a schematic view of a host server comprising the transaction controller and the interactive voice response system of the payment system of FIG. 1;

FIG. 3 is a flow diagram of a purchase conducted with the payment system of FIG. 1.

### DETAILED DESCRIPTION

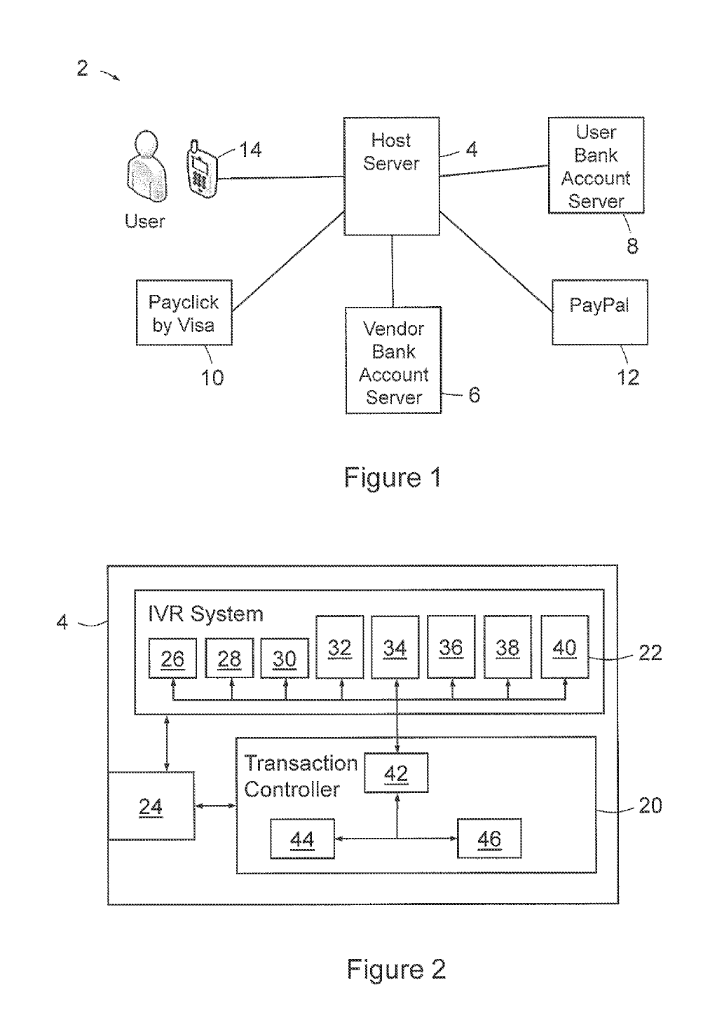

According to an embodiment of the present invention, there is provided a payment system 2 as depicted schematically at 10 in FIG. 1.

System 2 includes a host server 4 of a vendor, a vendor bank account server 6 (that is, a server operated by the bank with which the vendor has an account for receiving payments), a user bank account server 8 (that is, a server operated by the bank with which the user has an account from which funds are withdrawn to make a payment), a Payclick by Visa (trade mark) server 10 and a PayPal (trade mark) server 12. FIG. 1 also depicts a user telephone in the form of a mobile telephone 14, but this does not form a part of system 2 though it is used by the user to communicate with and interact with system 2.

Communications between host server 4 and vendor bank account server 6, user bank account server 8, Payclick by Visa server 10, PayPal server 12 and mobile telephone 14 are conducted over any suitable telecommunications network or networks. For example, between mobile telephone 14 and host server 4 communication is provided by a mobile telephony network and the internet, while between host server 4 and the bank account servers 14 and 16, communication is provided by the internet. All connections have the required security, as will be appreciated by those skilled in the art, and system 2—generally—meets PCI-DSS 3.0 requirements. System 2 reduces the risk of automated credit card (and the like) attacks, as it requires human interaction to effect a transaction, as is described below.

FIG. 2 is a schematic view of host server 4. Host server 4 has a transaction controller 20, an IVR system 22 and a communications bus 24 for input and output of data. Transaction controller 20, in broad terms, facilitates a transaction—typically a purchase—between the vendor and a user. IVR system 22 is provided to support voice based interaction between the user and transaction controller 20, both of the conventional type and, in addition, to validate the user (i.e. check that the user is a real person). Communications bus 24 exchanges data (including voice data) with, for example, vendor bank account server 6, user bank account server 8 and mobile telephone 14.

IVR system 22 includes the usual functionality of a conventional interactive voice response system but, in addition, IVR system 22 includes a processor 26 configured to control the output of voice prompts for transmission to a user (in this example, via mobile telephone 14), an alphanumeric string generator in the form of PIN generator 28 that is controlled by processor 26 to generate a random or pseudo-random four-digit number (or ‘PIN’) for outputting by processor 22 to the user in natural language form.

It should be appreciated that, in other embodiments, transaction controller 20 and IVR system 22 may be provided in separate servers or computing systems. For example, it may be more convenient to implement the invention by providing a stand-alone IVR system comparable to that of IVR system 22 that communicates with an existing, stand-alone transaction controller.

Referring again to FIG. 2, IVR system 22 includes a voice selection module 30 that selects respective voices randomly or pseudo-randomly, from a set of available voices (discussed below), in which each digit in the PIN should be outputted or ‘spoken’ to the user. For example, the PIN “9812” could be played or outputted as: ‘9’ in a young male voice, ‘8’ in a mature woman's voice, ‘1’ in a teenage girl's voice and ‘2’ in a mature man's voice. In this embodiment, the voices are chosen—as mentioned—randomly or pseudo-randomly, so occasionally the same voice might happen to be used twice (or more) in a single PIN. In another embodiment, voice selection module 30 constrains the selection of the voices by requiring that all four voices in any particular PIN be different. Voice selection module 30 outputs its selections to processor 26 for use by processor 26 in converting into voice form, or selecting, the digits of the PIN provided by PIN generator 28.

IVR system 22 includes a language controller 32 that controls processor 26 to output a menu of language options in voice form, to receive a user input (comprising a corresponding DTMF tone indicative of a selected language), and to control processor 26 to control the output of the PINs to be in the user-selected language.

IVR system 22 also includes a memory 34 that contains audio files, each containing a spoken version of a single digit (from ‘0’ to ‘9’) in one of a variety of voices (as discussed above) and languages. Thus, processor 26 selects the appropriate audio files according to the user-selected language (or a default language, such as English, if no user selection is received), the PIN provided by PIN generator 28 and the respective voices provided by voice selection module 30.

In another embodiment, IVR system 22 includes a voice synthesis system for converting the PIN (as generated by PIN generator 28) into spoken form in the selected language and voices. However, it is envisaged that a voice synthesis system will be more desirable in embodiments in which the alphanumeric string generator is not merely a PIN generator but instead is configured to generate combinations of letters (including combinations of letters and numerals or other characters), or words.

IVR system 22 includes a noise module 36. Once processor 26 has selected the appropriate audio files, processor 26 makes temporary copies the selected audio files; noise module 36 then modifies the content of each of the selected audio files by, in effect, adding noise. Noise is added at a level that allows should not prevent the attentive user from understanding the PIN, but which should reduce the likelihood that a voice recognition system can interpret the PIN correctly. This measure attempts to reduce the likelihood that system 2 could be misused by a third party with, for example, stolen credit card details and a ‘robot’ with a voice recognition system and programmed to masquerade as a user.

This can be done in any suitable manner. For example, memory 34 may contain a recording of white noise that can be added to each selected audio file at a suitable level or simply outputted to the user (again, a suitable level) while the selected audio files are themselves being outputted to the user. Essentially any form of noise may be used to modify the audio file content or be added thereto, such as—instead of white noise—noise in the form of a recording of: person or persons speaking, a conversation, traffic noise or background street-noise. It should also be appreciated that, in other embodiments, noise module 36 does not add noise in the strict sense, but simply distorts the audio file content by applying a filter or performing some other processing. Furthermore, a different type of noise (or distortion) can be added to each numeral (or in other embodiments, to each character or word).

The most effective type of noise and the highest acceptable level of the noise can be readily determined empirically, through tests with a voice recognition system and test users.

Processor 26 is configured to then output the phrase “Please enter the following PIN with your keypad, followed by hash” (or equivalent in the selected language) followed by the content of the audio files in sequence either as modified by noise module 36 or simultaneously with noise selected by noise module 36.

IVR system 22 includes an input module 38 for receiving a user response, recognizing numbers in the response and outputting—if one is recognized in the user response—a four digit numerical string (referred to herein as the “recognized number”).

It will be appreciated that, in other embodiments, the user response may be inputted in spoken form (in which case input module 38 would include a voice recognition system). In certain embodiments, the PIN is replaced by a alphanumeric string (of letters of the alphabet and/or numerals), to which the user may respond either using a keypad or in spoken form.

IVR system 22 includes a validation module 40 that receives the PIN from PIN generator 28 and the recognized number from input module 38, compares them and determines whether they match (in this embodiment, in numerical value). If so, validation module 40 outputs a “successful validation” code to transaction controller 20, so that whatever transaction is being or is to be conducted can proceed.

If a four digit numerical string cannot be recognized by input module 38 in the user's response, processor 26 controls IVR system 22 to repeat the original PIN to the user a predefined number of times (e.g. three or four times) until a four digit numerical string is recognized. Otherwise validation module 40 outputs a “failed validation” code to transaction controller 20. Similarly, if validation module 40 compares the PIN from PIN generator 28 and the recognized number from input module 38 but finds that they do not match, validation module 40 outputs a “failed validation” code to processor 26. Processor 26 responds by outputting a new PIN to the user until a validation code is outputted by validation module 40 (up to at most a predefined number of times, such as two or three times). If none of these PINs is successfully inputted (or recognized in the user response), validation module 40 outputs a “failed validation” code to transaction controller 20.

Transaction controller 20 is configured to mediate transactions on behalf of a vendor and the user, and includes a user interface module 42 for interacting with IVR system 22 (including to receive validation codes from validation module 40), banking module 44 for interacting with financial institutions and the like, and vendor module 46 for receiving transaction requests (whether made from websites, by telephone or otherwise).

In use, transaction controller 20 may receive, for example, a telephone request from a user—using mobile telephone 14—to recharge a pre-paid mobile telephone account. Transaction controller 20 processes this request in a generally conventional manner, including controlling IVR system 22 to interact with the user (to ascertain account details, recharge amount, etc), then controls IVR system 22 to request method of payment (credit card, debit card, PayPal, etc) and associated details. In addition, however, Transaction controller 20 controls IVR system 22 to output a PIN to the user and request that the user respond by entering that PIN (as described above) before it will accept the payment. That is, transaction controller 20 will only process the payment if it first receives a validation code from interface module 42.

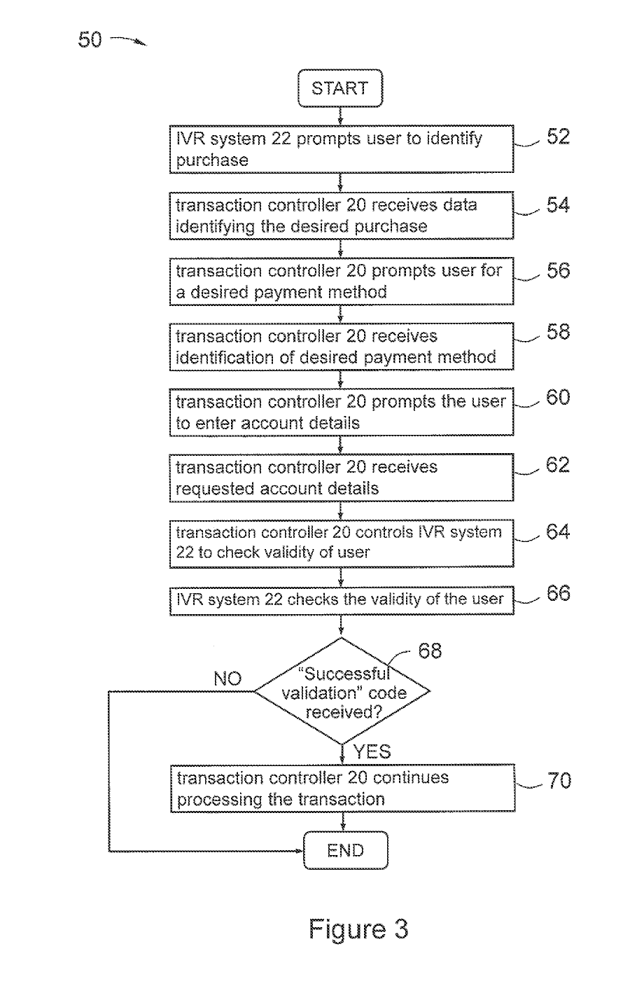

FIG. 3 is a flow diagram 50 of the method implemented by system 2, as used in the example of the purchase of a $100 mobile telephony recharge.

At step 52, transaction controller 20 controls IVR system 22 to ascertain the desired purchase by means of a series of voice prompts and corresponding user responses. At step 54, transaction controller 20 receives data from IVR system 22 identifying the desired purchase (in this example, the purchase of a $100 mobile telephony recharge for a specific carrier).

At step 56, transaction controller 20 (using IVR system 22) prompts the user to identify a desired payment method, and at step 58 transaction controller 20 receives identification of the desired payment method. At step 60, transaction controller 20 (using IVR system 22) prompts the user to enter account details (such as credit card number, expiry date and CCV). At step 62, transaction controller 20 receives the requested account details.

At step 64, transaction controller 20 controls IVR system 22 to check the validity of the user (i.e. as a real person), by outputting a PIN to the user and requesting that the user respond by entering that PIN. At step 66, IVR system 22 operates as described above to check the validity of the user. At step 68, transaction controller 20 monitors for receipt of either a “successful validation” code or a “failed validation” code from IVR system 22. If a “successful validation” code is received, processing continues at step 70, where transaction controller 20 continues to process the transaction along conventional lines, including check with the relevant financial instruction holds sufficient funds, etc.

If a “failed validation” code is received from IVR system 22 (or, after a predefined period, no response is received by transaction controller 20 from IVR system 22), processing ends—the transaction is terminated without attempting to further process the payment.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in any country.

The claims defining the invention are as follows:

1. An interactive voice response system, comprising:
a processor configured to control the output of voice prompts for transmission to a user;
an alphanumeric string generator controllable by the processor to generate a random or pseudo-random alphanumeric string for outputting by the processor to a user in natural language form;
an input module for receiving a user response and configured to recognize alphanumeric characters in said user response and to output a recognized string of one or more alphanumeric characters recognized in the user response; and
a validation module configured to receive the generated alphanumeric string from the alphanumeric string generator and the recognized string corresponding to the generated alphanumeric string from the input module, to compare the generated alphanumeric string with the recognized string, to determine whether the recognized string matches the generated alphanumeric string, and to output validation data in response to determining that the recognized string matches the generated alphanumeric string.

2. A system as claimed in claim 1, wherein the alphanumeric string generator is configured to output the generated alphanumeric string with each alphanumeric character rendered in a different voice.

3. A system as claimed in claim 2, wherein the system includes a voice selection module, configured to select respective voices randomly or pseudo-randomly from a set of available voices, or of recordings of characters, phrases or questions stored in a memory of the system, and to output said respective voices to said processor, wherein said processor is further configured to control the output of voice prompts according to said respective voices.

4. A system as claimed in claim 1, wherein the input module recognises keypad inputs.

5. A system as claimed in claim 1, wherein the input module comprises a voice recognition system and can recognise voice inputs.

6. A system as claimed in claim 1, wherein the generated alphanumeric string comprises only one or more numerals.

7. A system as claimed in claim 1, wherein the generated alphanumeric string comprises only one or more letters.

8. A system as claimed in claim 1, wherein the generated alphanumeric string comprises a combination of one or more numerals and one or more letters.

9. A system as claimed in claim 1, wherein the alphanumeric string generator is configured to change or select the length of the generated alphanumeric string periodically or randomly, or according to a predefined rule.

10. A system as claimed in claim 1, wherein the system is configured to output the generated alphanumeric string in natural language form either distorted or with noise.

11. A system as claimed in claim 1, wherein the system includes a language controller, configured to control the processor to output a menu of language options, to receive user input indicative of a selected language from said menu of language options, and to control said processor to control the output of voice prompts in said selected language.

12. An interactive voice response method, comprising:
generating a random or pseudo-random alphanumeric string;
outputting the generated alphanumeric string to a user in natural language form;
receiving a user response from the user;
electronically recognizing alphanumeric characters in said user response;
outputting a recognized string of one or more alphanumeric characters recognized in the user response; and
electronically comparing the generated alphanumeric string with the recognized string;
determining whether the recognized string matches the generated alphanumeric string; and
outputting validation data in response to determining that the recognized string matches the generated alphanumeric string.

13. A payment system, comprising an interactive voice response system as claimed in claim 1.

14. Computer software executable on a computing system for implementing the interactive voice response method as claimed in claim 12.
